(19) United States
(12) Patent Application Publication
(10) Pub. No.: US 2025/0145790 A1
(43) Pub. Date: May 8, 2025

(54) METHOD FOR REGENERATING BIODEGRADABLE POLYMERS

(71) Applicant: CJ CHEILJEDANG CORPORATION, Seoul (KR)

(72) Inventors: Jieun KIM, Seoul (KR); Youngsu YOU, Seoul (KR); Jinwoo JEON, Seoul (KR); Joo Young LEE, Seoul (KR); Jang-Woo SEO, Seoul (KR)

(73) Assignee: CJ CHEILJEDANG CORPORATION, Seoul (KR)

(21) Appl. No.: 18/835,604

(22) PCT Filed: Feb. 15, 2023
(86) PCT No.: PCT/KR2023/002194

§ 371 Date: Aug. 2, 2024

(30) Foreign Application Priority Data
Feb. 16, 2022 (KR) 10-2022-0020200

(51) Int. Cl. C08J 11/24; B01D 3/10; B01D 11/04; C08J 11/28

(52) U.S. Cl. CPC C08J 11/24; B01D 3/10; B01D 11/04; C08J 11/28

(57) ABSTRACT

The present invention relates to a method for regenerating biodegradable polymers. According to the method for regenerating biodegradable polymers, by reacting specific biodegradable polymers or a combination thereof with a depolymerization composition comprising a specific solvent and an acid catalyst, the specific biodegradable polymers or the combination thereof are monomerized with high yield at a relatively low temperature and thus could easily be regenerated as a raw material for initial polymer synthesis.

### TECHNICAL FIELD

The present disclosure relates to a process for regenerating a biodegradable polymer. Specifically, it relates to a process of decomposing a biodegradable polymer using a composition for depolymerization comprising a specific component to obtain monomers produced therefrom in a high yield.

### BACKGROUND ART

Plastic consumption has increased drastically over the past few decades. However, waste plastics do not decompose easily, causing serious environmental problems. In addition, in order to naturally decompose most discarded plastics, they are discharged to designated landfills. However, these plastics either partially decompose or persist for decades without decomposition depending on environmental factors such as ultraviolet rays, temperature, and the presence or absence of microorganisms for decomposition.

In recent years, biodegradable plastics, which have a relatively short decomposition cycle in nature, have been used to replace petroleum-based plastics. Representative examples thereof include polylactic acid (PLA), polyhydroxyalkanoate (PHA), and poly (butylene adipate-co-terephthalate) (PBAT). However, such biodegradable plastics also depend on several external factors (pH, temperature, humidity, carbon-nitrogen ratio, and the like) until they are completely decomposed, and it takes 90 days to 6 months, or up to several months, while such conditions are maintained. In addition, when biodegradable plastics are processed to enhance thermal resistance and mechanical properties, it causes slower decomposition.

To solve these problems, regeneration technologies for biodegradable plastics are being developed. As one of them, a monomerization technology through a chemical depolymerization technology for biodegradable plastics is being studied. In general, monomers produced through reactions such as hydrolysis, pyrolysis, and alcoholysis can theoretically have properties equivalent to those of the raw materials used in initial polymer synthesis.

As a process for regenerating a biodegradable plastic, a process for preparing lactic acid and its derivatives by alcoholysis of a polyester polymer material comprising a polylactic acid is known (Patent Document 1).

However, the above preparation process requires the use of a metal catalyst, which is a solid catalyst, for reasons such as ease of recovery of the catalyst, requires a long reaction time under high-temperature conditions, and still has limitations in achieving a high monomerization conversion yield.

### PRIOR ART DOCUMENT

### Patent Document

(Patent Document 1) Korean Patent No. 1730666

### DETAILED DESCRIPTION OF THE INVENTION

### Technical Problem

An object of the present disclosure is to provide a process in which a biodegradable polymer is readily decomposed at relatively low temperatures, is monomerized in a high yield, and is recycled as a raw material for the initial synthesis of a biodegradable polymer.

### Solution to the Problem

According to an aspect of the present disclosure, there is provided a process for regenerating a biodegradable polymer, which comprises reacting a biodegradable polymer with a composition for depolymerization to obtain a monomer mixture, wherein the biodegradable polymer comprises a polylactic acid (PLA), a polyhydroxyalkanoate (PHA), or a combination thereof, the composition for depolymerization comprises a primary alcohol, a non-polar aprotic solvent, and a Brønsted-Lowry acid catalyst, and the reaction is carried out at 90° C. or higher.

In an embodiment, the biodegradable polymer may comprise a polylactic acid (PLA) and a polyhydroxyalkanoate (PHA), and the weight ratio of the polylactic acid (PLA) and the polyhydroxyalkanoate (PHA) may be 1:9 to 9:1.

In another embodiment, the monomer mixture may comprise lactic acid or a derivative thereof, 3-hydroxybutyrate or a derivative thereof, and 4-hydroxybutyrate or a derivative thereof.

In another embodiment, the Brønsted-Lowry acid catalyst may comprise at least one selected from the group consisting of sulfuric acid, hydrochloric acid, and nitric acid.

In another embodiment, the non-polar aprotic solvent may comprise at least one selected from the group consisting of 1,4-dioxane, chloroform, and tetrahydrofuran.

In another embodiment, the primary alcohol may be ethanol, butanol, or a combination thereof.

In another embodiment, the process comprises preparing the composition for depolymerization, wherein the step of preparing the composition for depolymerization may comprise mixing the primary alcohol and the non-polar aprotic solvent in which the Brønsted-Lowry acid catalyst is dissolved at a volume ratio of 1:0.2 to 20.

In another embodiment, the Brønsted-Lowry acid catalyst may be employed in an amount of 0.01 to 100 equivalents based on the total weight of the composition for depolymerization.

In another embodiment, the reaction may be carried out at 90° C. to 120° C.

In another embodiment, the process for regenerating a biodegradable polymer may have a monomerization conversion yield of 80% or more.

In another embodiment, the process for regenerating a biodegradable polymer may further comprise, after obtaining the monomer mixture, carrying out a distillation process to separate a monomer from the monomer mixture and recover it.

In another embodiment, the process for regenerating a biodegradable polymer may further comprise, after obtaining the monomer mixture and before the distillation process, separating the monomer mixture into two layers using liquid-liquid extraction.

In another embodiment, the distillation process may be carried out at a temperature of 50° C. to 250° C. and a reduced pressure of 10 to 760 Torr.

In another embodiment, the process may further comprise repolymerizing the recovered monomers to obtain a biodegradable polymer.

### Advantageous Effects of the Invention

In the process for regenerating a biodegradable polymer according to an embodiment, a biodegradable polymer of specific materials or a combination thereof is reacted with a composition for depolymerization comprising a specific solvent and a specific acid catalyst, whereby it can be monomerized in a high yield at relatively low temperatures and readily recycled as a raw material for initial polymer synthesis.

In addition, when a distillation process is carried out under specific conditions after the reaction to perform a subsequent process to separate a monomer from a monomer mixture and recover it, a higher monomer conversion yield can be achieved in a simple and economical manner.

Further, the monomers recovered in a high yield may be repolymerized to obtain a biodegradable polymer in an economical and efficient manner.

### BRIEF DESCRIPTION OF THE DRAWING

FIG. 1 shows a flow chart of the process of regenerating a biodegradable polymer according to an embodiment of the present disclosure.

### BEST MODE FOR CARRYING OUT THE INVENTION

Hereinafter, the present disclosure will be described in detail with reference to embodiments. The embodiments are not limited to those described below. Rather, they can be modified into various forms as long as the gist of the invention is not altered.

Throughout the present specification, when a part is referred to as “comprising” an element, it is understood that other elements may be comprised, rather than other elements are excluded, unless specifically stated otherwise.

In addition, all numbers expressing the physical properties, dimensions, and the like of elements used herein are to be understood as being modified by the term “about” unless otherwise indicated.

The process for regenerating a biodegradable polymer according to an embodiment of the present disclosure comprises reacting a biodegradable polymer with a composition for depolymerization to obtain a monomer mixture, wherein the biodegradable polymer comprises a polylactic acid (PLA), a polyhydroxyalkanoate (PHA), or a combination thereof, the composition for depolymerization comprises a primary alcohol, a non-polar aprotic solvent, and a Brønsted-Lowry acid catalyst, and the reaction is carried out at 90° C. or higher.

In the process for regenerating a biodegradable polymer, a biodegradable polymer of specific materials or a combination thereof is reacted with a composition for depolymerization comprising a specific solvent and a specific acid catalyst, whereby it can be monomerized in a high yield at relatively low temperatures.

Hereinafter, each component used in the process for regenerating a biodegradable polymer will be described in detail.

### Biodegradable Polymer

The biodegradable polymer may comprise a polylactic acid (PLA), a polyhydroxyalkanoate (PHA), or a combination thereof.

For example, the biodegradable polymer may comprise a polylactic acid (PLA).

Since the polylactic acid (PLA), unlike petroleum-based resins, is based on biomass, renewable resources can be used. It emits less carbon dioxide, the main cause of global warming, during its production as compared with conventional resins and is environmentally friendly as it is biodegraded by moisture and microorganisms when landfilled.

The polylactic acid (PLA) may have a weight average molecular weight (Mw) of 10,000 to 1,000,000 g/mole, for example, 30,000 to 500,000 g/mole, 100,000 to 300,000 g/mole, or 100,000 to 200,000 g/mole. The weight average molecular weight (Mw) may be measured by gel permeation chromatography (GPC).

The polylactic acid (PLA) may comprise L-lactic acid, D-lactic acid, D,L-lactic acid, or a combination thereof.

Specifically, the polylactic acid (PLA) may be a random copolymer of L-lactic acid and D-lactic acid.

The polylactic acid (PLA) may have a melting temperature (Tm) of 100° C. to 300° C., 120° C. to 250° C., or 120° C. to 200° C.

The polylactic acid (PLA) may have a glass transition temperature (Tg) of 30° C. to 100° C., 30° C. to 80° C., 40° C. to 80° C., or 45° C. to 70° C.

As another example, the biodegradable polymer may comprise a polyhydroxyalkanoate (PHA).

The polyhydroxyalkanoate (PHA) has physical properties similar to those of conventional petroleum-derived synthetic polymers such as polybutylene adipate terephthalate (PBAT), polybutylene succinate (PBS), polybutylene succinate terephthalate (PBST), and polybutylene succinate adipate (PBSA), exhibits complete biodegradability, and is excellent in biocompatibility.

Specifically, the polyhydroxyalkanoate (PHA) may be a copolymer comprising two or more different monomers with the monomers randomly distributed in the polymer chain.

Examples of repeat units that may be contained in the polyhydroxyalkanoate (PHA) include 2-hydroxybutyrate, lactic acid, glycolic acid, 3-hydroxybutyrate (hereinafter, referred to as 3-HB), 3-hydroxypropionate (hereinafter, referred to as 3-HP), 3-hydroxyvalerate (hereinafter, referred to as 3-HV), 3-hydroxyhexanoate (hereinafter, referred to as 3-HH), 3-hydroxyheptanoate (hereinafter, referred to as 3-HHep), 3-hydroxyoctanoate (hereinafter, referred to as 3-HO), 3-hydroxynonanoate (hereinafter, referred to as 3-HN), 3-hydroxydecanoate (hereinafter, referred to as 3-HD), 3-hydroxydodecanoate (hereinafter, referred to as 3-HDd), 4-hydroxybutyrate (hereinafter, referred to as 4-HB), 4-hydroxyvalerate (hereinafter, referred to as 4-HIV), 5-hydroxyvalerate (hereinafter, referred to as 5-HV), and 6-hydroxyhexanoate (hereinafter, referred to as 6-HH). The polyhydroxyalkanoate (PHA) may comprise one or more repeat units selected from the above.

Specifically, the polyhydroxyalkanoate (PHA) may comprise one or more repeat units selected from the group consisting of 3-HB, 4-HB, 3-HP, 3-HH, 3-HV, and 4-HV.

More specifically, the polyhydroxyalkanoate (PHA) may comprise a 4-HV repeat unit. That is, the polyhydroxyalkanoate (PHA) may be a PHA copolymer comprising a 4-HV repeat unit.

In addition, the polyhydroxyalkanoate (PHA) may comprise isomers. For example, the PHA may comprise structural isomers, enantiomers, or geometric isomers. Specifically, the polyhydroxyalkanoate (PHA) may comprise structural isomers.

In addition, the polyhydroxyalkanoate (PHA) may be a PHA copolymer that comprises a 4-HB repeat unit and further comprises one repeat unit different from the 4-HB repeat unit, or further comprises two, three, four, five, six, or more repeat units different from each other.

According to an embodiment of the present disclosure, the polyhydroxyalkanoate (PHA) may comprise a copolymerized polyhydroxyalkanoate comprising at least one repeat unit selected from the group consisting of 3-HB, 3-HP, 3-HH, 3-HV, and 4-HV, and a 4-HB repeat unit.

Specifically, the PHA copolymer may comprise a 4-HB repeat unit and further comprises one or more repeat units selected from the group consisting of a 3-HB repeat unit, a 3-HP repeat unit, a 3-HH repeat unit, a 3-HV repeat unit, and a 4-HV repeat unit. More specifically, the polyhydroxyalkanoate (PHA) may be a copolymerized polyhydroxyalkanoate comprising a 3-HB repeat unit and a 4-HB repeat unit.

For example, the polyhydroxyalkanoate (PHA) may be poly-3-hydroxybutyrate-co-4-hydroxybutyrate (hereinafter, referred to as 3-HB-co-4-HB).

More specifically, the PHA copolymer may comprise a 4-HB repeat unit in an amount of 0.1% by weight to 60% by weight based on the total weight of the PHA copolymer. For example, the content of the 4-HB repeat unit may be 0.1% by weight to 55% by weight, 0.5% by weight to 60% by weight, 0.5% by weight to 55% by weight, 1% by weight to 60% by weight, 1% by weight to 55% by weight, 1% by weight to 50% by weight, 2% by weight to 55% by weight, 3% by weight to 55% by weight, 3% by weight to 50% by weight, 5% by weight to 55% by weight, 5% by weight to 50% by weight, 10% by weight to 55% by weight, 10% by weight to 50% by weight, 1% by weight to 40% by weight, 1% by weight to 30% by weight, 1% by weight to 29% by weight, 1% by weight to 25% by weight, 1% by weight to 24% by weight, 2% by weight to 20% by weight, 2% by weight to 23% by weight, 3% by weight to 20% by weight, 3% by weight to 15% by weight, 4% by weight to 18% by weight, 5% by weight to 15% by weight, 8% by weight to 12% by weight, 9% by weight to 12% by weight, 15% by weight to 55% by weight, 15% by weight to 50% by weight, 20% by weight to 55% by weight, 20% by weight to 50% by weight, 25% by weight to 55% by weight, 25% by weight to 50% by weight, 35% by weight to 60% by weight, 40% by weight to 55% by weight, or 45% by weight to 55% by weight, based on the total weight of the PHA copolymer.

Meanwhile, the polyhydroxyalkanoate (PHA) may have a glass transition temperature (Tg) of, for example, −45° C. to 80° C., −35° C. to 80° C., −30° C. to 80° C., −25° C. to 75° C., −20° C. to 70° C., −35° C. to 5° C., −25° C. to 5° C., −35° C. to 0° C., −25° C. to 0° C., −30° C. to −10° C., −35° C. to −15° C., −35° C. to −20° C., −20° C. to 0° C., −15° C. to 0° C., or −15° C. to −5° C.

In addition, the polyhydroxyalkanoate (PHA) may have a weight average molecular weight of, for example, 10,000 g/mole to 1,200,000 g/mole. For example, the weight average molecular weight of the PHA resin may be 50,000 g/mole to 1,200,000 g/mole, 100,000 g/mole to 1,200,000 g/mole, 50,000 g/mole to 1,000,000 g/mole, 100,000 g/mole to 1,000,000 g/mole, 200,000 g/mole to 1,200,000 g/mole, 250,000 g/mole to 1,150,000 g/mole, 300,000 g/mole to 1,100,000 g/mole, 350,000 g/mole to 1,000,000 g/mole, 350,000 g/mole to 950,000 g/mole, 100,000 g/mole to 900,000 g/mole, 200,000 g/mole to 800,000 g/mole, 200,000 g/mole to 700,000 g/mole, 250,000 g/mole to 650,000 g/mole, 200,000 g/mole to 400,000 g/mole, 300,000 g/mole to 800,000 g/mole, 300,000 g/mole to 600,000 g/mole, 500,000 g/mole to 1,200,000 g/mole, 500,000 g/mole to 1,000,000 g/mole 550,000 g/mole to 1,050,000 g/mole, 550,000 g/mole to 900,000 g/mole, or 600,000 g/mole to 900,000 g/mole.

As another example, the biodegradable polymer may comprise a combination of a polylactic acid (PLA) and a polyhydroxyalkanoate (PHA).

In such a case, the weight ratio of the polylactic acid (PLA) and the polyhydroxyalkanoate (PHA) may be, for example, 1:9 to 9:1, for example, 2:8 to 8:2, or, for example, 3:7 to 7:3.

According to an embodiment of the present disclosure, the monomer mixture obtained by the above reaction may comprise one or more selected from the group consisting of lactic acid (LA), 3-hydroxybutyrate (3-HB), and 4-hydroxybutyrate (4-HB), derivatives thereof, or combinations thereof. Specifically, the monomer mixture may comprise esterified monomers produced through an esterification reaction.

For example, when the biodegradable polymer is a polylactic acid (PLA), the monomer mixture may comprise lactic acid (LA) or a derivative thereof. Specifically, the monomer mixture may comprise an alkyl lactic acid (alkyl-LA), for example, methyl lactic acid (methyl-LA), ethyl lactic acid (ethyl-LA), propyl lactic acid (propyl-LA), or butyl lactic acid (butyl-LA). For example, the monomer mixture may vary depending on the type of alcohol. For example, when ethanol or butanol is used as the alcohol, the monomer mixture may comprise ethyl lactic acid (ethyl-LA) or butyl lactic acid (butyl-LA).

In addition, when the biodegradable polymer comprises a polyhydroxyalkanoate (PHA), the monomer mixture may comprise 3-hydroxybutyrate (3-HB) and 4-hydroxybutyrate (4-HB), or derivatives thereof. Specifically, the monomer mixture may comprise an alkyl 3-hydroxybutyrate (alkyl 3-HB) and an alkyl 4-hydroxybutyrate (alkyl 4-HB), for example, methyl 3-hydroxybutyrate (methyl 3-HB) and methyl 4-hydroxybutyrate (methyl 4-HB); ethyl 3-hydroxybutyrate (ethyl 3-HB) and ethyl 4-hydroxybutyrate (ethyl 4-HB); propyl 3-hydroxybutyrate (propyl 3-HB) and propyl 4-hydroxybutyrate (propyl 4-HB); or butyl 3-hydroxybutyrate (butyl 3-HB) and butyl 4-hydroxybutyrate (butyl 4-HB).

For example, the monomer mixture may vary depending on the type of alcohol. For example, when ethanol or butanol is used as the alcohol, the monomer mixture may comprise ethyl 3-hydroxybutyrate (ethyl 3-HB) and ethyl 4-hydroxybutyrate (ethyl 4-HB); or butyl 3-hydroxybutyrate (butyl 3-HB) and butyl 4-hydroxybutyrate (butyl 4-HB).

In addition, when the biodegradable polymer comprises a combination of a polylactic acid (PLA) and a polyhydroxyalkanoate (PHA), the monomer mixture may comprise lactic acid or a derivative thereof, 3-hydroxybutyrate or a derivative thereof, and 4-hydroxybutyrate or a derivative thereof. Specifically, the monomer mixture may comprise an alkyl lactic acid (alkyl-LA), an alkyl 3-hydroxybutyrate (alkyl 3-HB), and an alkyl 4-hydroxybutyrate (alkyl 4-HB), for example, methyl lactic acid (methyl-LA), methyl 3-hydroxybutyrate (methyl 3-HB), and methyl 4-hydroxybutyrate (methyl 4-HB); ethyl lactic acid (methyl-LA), ethyl 3-hydroxybutyrate (ethyl 3-HB), and ethyl 4-hydroxybutyrate (ethyl 4-HB); propyl lactic acid (propyl-LA), propyl 3-hydroxybutyrate (propyl 3-HB), and propyl 4-hydroxybutyrate (propyl 4-HB); or butyl lactic acid (butyl-LA), butyl 3-hydroxybutyrate (butyl 3-HB), and butyl 4-hydroxybutyrate (butyl 4-HB). For example, the monomer mixture may vary depending on the type of alcohol. For example, when ethanol or butanol is used as the alcohol, the monomer mixture may comprise ethyl lactic acid (methyl-LA), ethyl 3-hydroxybutyrate (ethyl 3-HB), and ethyl 4-hydroxybutyrate (ethyl 4-HB); or butyl lactic acid (butyl-LA), butyl 3-hydroxybutyrate (butyl 3-HB), and butyl 4-hydroxybutyrate (butyl 4-HB).

In addition, the biodegradable polymer used in the present disclosure may not be in a pure state; rather, it may be in a processed form or in a state containing various impurities. As an example, a mixture of debris, including, but not limited to, bottle caps, adhesives, paper, residual liquid, dust, or combinations thereof, in addition to the above biodegradable polymer, may be used as raw materials for the regeneration process of the present disclosure.

### Composition for Depolymerization

Meanwhile, the composition for depolymerization may comprise a primary alcohol, a non-polar aprotic solvent, and a Brønsted-Lowry acid catalyst.

### Primary Alcohol

The primary alcohol may comprise an alcohol having 1 to 4 carbon atoms that does not contain halogen. For example, the primary alcohol may comprise methanol, ethanol, propanol, butanol, or a combination thereof. Specifically, the primary alcohol may comprise ethanol, butanol, or a combination thereof.

When the primary alcohol comprises an alcohol having 1 to 4 carbon atoms that does not contain halogen, the primary alcohol has low toxicity and is an environmentally friendly alcohol with little harm to the human body since it does not contain halogen. Thus, an environmentally friendly biodegradable polymer can be monomerized in an environmentally friendly manner. In particular, when the above type of primary alcohol is used, the ester functional group can be easily cleaved, which can be advantageous in terms of the reaction process.

### Non-Polar Aprotic Solvent

Meanwhile, the non-polar aprotic solvent may be a non-polar aprotic solvent that does not contain halogen. Typically, the non-polar aprotic solvent may comprise at least one selected from the group consisting of 1,4-dioxane, chloroform, and tetrahydrofuran.

When the non-polar aprotic solvent is used, the non-polar aprotic solvent has low toxicity and is an environmentally friendly solvent with little harm to the human body since it does not contain halogen. Thus, an environmentally friendly biodegradable polymer can be monomerized in an environmentally friendly manner. In addition, since it is more advantageous in swelling the biodegradable polymer or dissolving the produced monomers, it is possible to further enhance the conversion yield of each monomer.

### BrøNsted-Lowry Acid Catalyst

Meanwhile, the Brønsted-Lowry acid catalyst may comprise at least one selected from the group consisting of sulfuric acid, hydrochloric acid, and nitric acid. For example, the Brønsted-Lowry acid catalyst may comprise at least one selected from the group consisting of sulfuric acid and hydrochloric acid. In addition, the Brønsted-Lowry acid catalyst may comprise at least one selected from the group consisting of hydrochloric acid and nitric acid. In addition, the Brønsted-Lowry acid catalyst may be hydrochloric acid.

When the above Brønsted-Lowry acid catalyst is used, monomerization in high conversion yield is possible through a simple process even at a low temperature of about 90° C.

If the composition for depolymerization does not comprise the Brønsted-Lowry acid catalyst, monomerization of units (monomers) derived from the biodegradable polymer may not be carried out; or even if monomerization is carried out, the monomerization conversion yield may be very low.

In addition, if the composition for depolymerization comprises a solid catalyst such as a metal catalyst, rather than the Brønsted-Lowry acid catalyst, monomerization of units derived from the biodegradable polymer may not be readily carried out; or even if monomerization is carried out, the monomerization conversion yield may be very low. In particular, when the biodegradable polymer comprises a polyhydroxyalkanoate (PHA, 3-HB-co-4-HB), the yield of 3-hydroxybutyrate (3HB) monomer conversion may be particularly very low, or no monomer conversion may be carried out.

In addition, according to an embodiment of the present disclosure, the Brønsted-Lowry acid catalyst may be mixed in a state dissolved in the non-polar aprotic solvent.

Specifically, the Brønsted-Lowry acid catalyst may be mixed in a state dissolved in, for example, 1,4-dioxane. More specifically, hydrochloric acid may be mixed in a state dissolved in 1,4-dioxane. For example, hydrochloric acid may be dissolved in 1,4-dioxane at 1 to 6 M, 2 to 5 M, or 3 to 5 M to be used.

The mixing volume ratio of the primary alcohol and the solution in which the Brønsted-Lowry acid catalyst is dissolved in the non-polar aprotic solvent may be, for example, 1:0.2 to 20, for example, 1:0.2 to 10, for example, 1:0.2 to 6, for example, 1:0.2 to 3, or, for example, 1:1. When the mixing volume ratio of the primary alcohol and the solution in which the Brønsted-Lowry acid catalyst is dissolved in the non-polar aprotic solvent satisfies the above range, it may be more advantageous for achieving a high monomerization conversion yield.

The Brønsted-Lowry acid catalyst may be employed in an amount of 0.01 to 100 equivalents, for example, 0.01 to 50 equivalents, or, for example, 0.01 to 30 equivalents, based on the total weight of the composition for depolymerization. When the content of the Brønsted-Lowry acid catalyst satisfies the above range, monomerization in high conversion yield is possible even at relatively low temperatures.

### Process for Regenerating a Biodegradable Polymer

The process for regenerating a biodegradable polymer according to an embodiment of the present disclosure comprises reacting a biodegradable polymer with the composition for depolymerization to obtain a monomer mixture.

### Preparation of a Composition for Depolymerization

The step of preparing a composition for depolymerization may comprise mixing the primary alcohol and the solution in which the Brønsted-Lowry acid catalyst is dissolved in the non-polar aprotic solvent at a volume ratio of, for example, 1:0.2 to 20, for example, 1:0.2 to 10, for example, 1:0.2 to 6, for example, 1:0.2 to 3, or, for example, 1:1. When the mixing volume ratio of the primary alcohol and the solution in which the Brønsted-Lowry acid catalyst is dissolved in the non-polar aprotic solvent satisfies the above range, it may be more advantageous for achieving a high monomerization conversion yield.

The specific content of the Brønsted-Lowry acid catalyst is as described above.

### Depolymerization to Obtain a Monomer Mixture

The process for regenerating a biodegradable polymer according to an embodiment of the present disclosure comprises reacting a biodegradable polymer with the composition for depolymerization to obtain a monomer mixture.

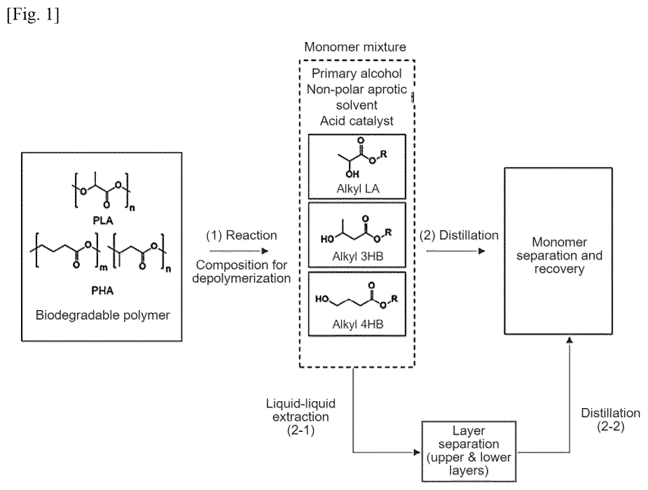

Referring to FIG. 1, in the process for regenerating a biodegradable polymer, the reaction (1) to obtain the monomer mixture may be an esterification reaction, and the reaction temperature may be 90° C. or higher. Specifically, the reaction temperature may be, for example, 90° C. to 120° C., for example, 95° C. to 120° C., for example, 90° C. to 110° C., or, for example, 100° C. to 120° C. When the above reaction temperature is satisfied, the monomerization conversion yield can be increased to optimal conditions, and it is preferable from an economic standpoint. If the reaction temperature is lower than 90° C., the monomerization conversion yield may be lowered due to the low reaction temperature. In addition, if the reaction temperature exceeds 120° C., it may be undesirable from an economic standpoint.

In addition, the reaction time may vary depending on the amount of the biodegradable polymer used. It may be carried out for, for example, 4 to 24 hours, for example, 4 to 12 hours, or, for example, 4 to 8 hours.

In addition, during the reaction, the stirring speed of the biodegradable polymer and the composition for depolymerization may be, for example, 50 rpm to 700 rpm, for example, 50 rpm to 500 rpm, or, for example, 50 rpm to 300 rpm. When it is carried out under the above reaction conditions, a high monomer conversion yield can be achieved efficiently at relatively low temperatures.

In addition, the process for regenerating a biodegradable polymer of the present disclosure may be carried out under atmospheric pressure to about 5 atm. For example, in the process for regenerating a biodegradable polymer, when the above reaction is carried out at atmospheric pressure, it is more advantageous for achieving the object of the present disclosure and may also be advantageous from the viewpoint of economics and efficiency.

In addition, the reaction may be carried out, for example, in a hot water bath. After the reaction, it may be completely cooled in an ice bath. In such a case, it may be more advantageous for achieving a high monomer conversion yield can be achieved efficiently at relatively low temperatures.

Meanwhile, according to an embodiment of the present disclosure, after the above reaction, a step of separating and removing an unreacted biodegradable polymer material from the monomer mixture by filtration may be additionally carried out. Specifically, the monomer mixture may be filtered to obtain a filter cake, and the filter cake may be washed with additional alcohol or deionized water.

### Separation and Recovery of Monomers

The process for regenerating a biodegradable polymer may further comprise, after obtaining the monomer mixture, separating and recovering monomers from the monomer mixture.

Referring back to FIG. 1, the process may further comprise, after obtaining the monomer mixture, carrying out a distillation process (2) to separate a monomer from the monomer mixture and recover it.

The distillation process may be carried out using a commonly used distillation method to separate a monomer from the monomer mixture and recover it. For example, the monomer mixture is heated in the receiver of a distillation column, and the vapor generated from the top of the distillation column is condensed with the condenser to separate a monomer and recover it.

The distillation process may be carried out at a temperature (heated temperature) of 50° C. to 250° C. and a reduced pressure of 10 to 760 Torr. Specifically, the distillation process may be carried out at a temperature of, for example, 50° C. to 200° C. or, for example, 80° C. to 200° C. and a reduced pressure of, for example, 20 to 700 Torr or, for example, 30 to 500 Torr. In the distillation process, the temperature and/or reduced pressure conditions may vary depending on the type of primary alcohol.

In addition, referring back to FIG. 1, according to an embodiment of the present disclosure, after the step of obtaining the monomer mixture, the monomer mixture may be separated into, for example, an upper layer (organic layer) and a lower layer (distilled water layer) using liquid-liquid extraction (2-1), and a distillation process (2-2) may be carried out to separate a monomer from the monomer mixture and recover it.

That is, the process for regenerating a biodegradable polymer may further comprise, after obtaining the monomer mixture and before the distillation process, separating the monomer mixture into two layers using liquid-liquid extraction.

Specifically, the layer separation of the monomer mixture using the liquid-liquid extraction may comprise adding distilled water in the same volume as the composition for depolymerization to the monomer mixture, shaking it sufficiently for several minutes to carry out the liquid-liquid extraction, and, upon completion of the extraction, leaving it to allow the layer separation to be completely carried out and to recover the upper layer (organic layer) and lower layer (distilled water layer) of the separated product, respectively.

In such an event, the materials present in the upper layer and the lower layer of the layer-separated product may vary depending on the type of primary alcohol used.

Specifically, the upper layer may comprise a non-polar aprotic solvent and/or at least one selected from the group consisting of lactic acid or a derivative thereof, 3-hydroxybutyrate or a derivative thereof, and 4-hydroxybutyrate or a derivative thereof, as a reaction product. The lower layer may comprise water, a primary alcohol, a Brønsted-Lowry acid catalyst, and at least one selected from the group consisting of lactic acid or a derivative thereof, 3-hydroxybutyrate or a derivative thereof, and 4-hydroxybutyrate or a derivative thereof, as a reaction product.

For example, when n-butanol is used as the primary alcohol, the upper layer may comprise a non-polar aprotic solvent and/or at least one selected from the group consisting of lactic acid or a derivative thereof, 3-hydroxybutyrate or a derivative thereof, and 4-hydroxybutyrate or a derivative thereof, as a reaction product, and the lower layer may comprise water, a Brønsted-Lowry acid catalyst, n-butanol, and the above reaction product.

As another example, when ethanol is used as the primary alcohol, the upper layer may comprise a non-polar aprotic solvent, and the lower layer may comprise water, a Brønsted-Lowry acid catalyst, ethanol, and the above reaction product.

After the layer separation of the monomer mixture using the liquid-liquid extraction is carried out (2-1), the distillation process (2-2) described above may be carried out to separate a monomer from the monomer mixture. In such a case, monomer loss can be suppressed, and the monomerization conversion rate can be further enhanced.

Meanwhile, the monomer conversion yield can be confirmed by chromatographic analysis of the materials recovered according to the process for regenerating a biodegradable polymer.

The chromatographic analysis may be carried out by, for example, gas chromatography (GC) and/or high-performance liquid chromatography (HPLC).

The gas chromatography analysis may be carried out using, for example, GC (Agilent Technologies) equipped with a DB-FFAP (60 m×250 μm×0.25 μm) column and a flame ionization detector (FID). The analysis results may be calculated by measuring the peak area ratio of the internal standard substance, diphenylmethane, and the sample. The content of the reaction product can be measured by the gas chromatography analysis.

The high-performance liquid chromatography analysis may be carried out using HPLC (Agilent Technologies) equipped with a Capcell Pak C18 MG (4.6 mm×250 mm×5 μm) column and a diode array detector (DAD) of a 210-nm wavelength. In addition, in the analysis, an aqueous phosphoric acid solution and acetonitrile containing phosphoric acid may be used as a solvent for the mobile phase by varying the concentration, and the flow rate may be about 0.5 mL/minute to 3 mL/minute, for example, about 1 mL/minute. The yield (content) of the monomers (monomerization-converted materials) and the oligomers of the unreacted biodegradable polymer can be measured through the high-performance liquid chromatography analysis.

Meanwhile, the monomerization conversion yield of the units (monomers) derived from the biodegradable polymer can be calculated by the following Equation I using the chromatographic analysis:

### [Equation 1]

$$Monomerization conversion yield ( \% ) = \frac{{W}_{r}}{{W}_{p}} \times 100$$

In Equation 1, Wₚ is the weight (% by weight) of the biodegradable polymer, and Wᵣ is the total weight (% by weight) of the monomerization-converted materials produced.

According to an embodiment of the present disclosure, the monomers of a biodegradable polymer obtained from the process for regenerating a biodegradable polymer may have a monomerization conversion yield of, for example, 80% or more, for example, 82% or more, for example, 85% or more, for example, 90% or more, for example, 92% or more, for example, 95% or more, for example, 96% or more, or, for example, 97% or more.

For example, when the biodegradable polymer is a polylactic acid (PLA), the monomerization conversion yield of lactic acid (LA) or a derivative thereof derived from the biodegradable polymer, specifically, the monomerization conversion yield of an alkyl lactic acid (alkyl LA), may be, for example, 80% or more, for example, 82% or more, for example, 84% or more, for example, 85% or more, for example, 86% or more, or, for example, 87% or more.

In addition, when the biodegradable polymer is a polyhydroxyalkanoate (PHA), the monomerization conversion yield of 3-hydroxybutyrate (3-HB) or a derivative thereof, and 4-hydroxybutyrate (4-HB) or a derivative thereof, derived from the biodegradable polymer, specifically, the monomerization conversion yield of an alkyl 3-hydroxybutyrate (alkyl 3-HB) and an alkyl 4-hydroxybutyrate (alkyl 4-HB), may each be, for example, 85% or more, for example, 88% or more, for example, 90% or more, for example, 95% or more, for example, 96% or more, for example, 97% or more, for example, 98% or more, for example, 99% or more, or, for example, 100%.

In addition, when the biodegradable polymer is a combination of a polylactic acid (PLA) and a polyhydroxyalkanoate (PHA), the monomerization conversion yield of lactic acid (LA) or a derivative thereof derived from the biodegradable polymers, specifically, the monomerization conversion yield of an alkyl lactic acid (alkyl LA), may be, for example, 80% or more, for example, 81% or more, or, for example, 82% or more. In addition, the monomerization conversion yield of 3-hydroxybutyrate (3-HB) or a derivative thereof derived from the biodegradable polymers, specifically, the monomerization conversion yield of an alkyl 3-hydroxybutyrate (alkyl 3-HB) may be, for example, 85% or more, for example, 88% or more, for example, 90% or more, for example, 95% or more, for example, 96% or more, for example, 97% or more, for example, 98% or more, for example, 99% or more, or, for example, 100%. In addition, the monomerization conversion yield of 4-hydroxybutyrate (4-HB) or a derivative thereof derived from the biodegradable polymers, specifically, the monomerization conversion yield of an alkyl 4-hydroxybutyrate (alkyl 4-HB) may be, for example, 85% or more, for example, 88% or more, for example, 90% or more, for example, 95% or more, for example, 96% or more, for example, 97% or more, for example, 98% or more, for example, 99% or more, or, for example, 100%.

In the process for regenerating a biodegradable polymer according to an embodiment, a biodegradable polymer of specific materials or a combination thereof is reacted with a composition for depolymerization comprising a specific solvent and a specific acid catalyst, whereby it can be monomerized in a high yield at relatively low temperatures and readily recycled as a raw material for initial polymer synthesis.

Further, the monomers may be separately recovered and polymerized (re-polymerized) to obtain a biodegradable polymer such as a polylactic acid (PLA), a polyhydroxyalkanoate (PHA), or a combination thereof. The polymerization (repolymerization) process may be carried out using a conventional method.

### EMBODIMENTS FOR CARRYING OUT THE INVENTION

Hereinafter, the present disclosure will be described in detail with reference to Examples. But the following examples are intended to illustrate the present disclosure, and the scope of the present disclosure is not limited thereto only.

### EXAMPLE

### Example 1

Butanol (n-butanol) as a primary alcohol and 1,4-dioxane (non-polar aprotic solvent) dissolved 4M hydrochloric acid as a Brønsted-Lowry acid catalyst (4 M HCl in 1,4-dioxane) were mixed at a volume ratio of 1:1 to prepare a solution. Diphenylmethane, an internal standard, was dissolved in the solution at a concentration of 2 g/L to prepare a composition for depolymerization.

A polylactic acid (PLA, Nature Works LLC (US)), a biodegradable polymer, was reacted with the composition for depolymerization in a screw-capped glass test tube in a hot water bath at 95° C. The reactant was stirred at a speed of 150 rpm and reacted for 6 hours. The product thus obtained was completely cooled in an ice bath to obtain a monomer mixture.

In order to separate a monomer from the monomer mixture, the same volume of distilled water as that of the composition for depolymerization was added to the monomer mixture, which was shaken sufficiently to separate the monomer mixture into two layers using liquid-liquid extraction. It was left to allow the layer separation to be completely carried out. The upper layer (organic layer) of the separated product was collected and analyzed by gas chromatography (GC). The separated lower layer (distilled water layer) was analyzed by high-performance liquid chromatography (HPLC).

The gas chromatography analysis was carried out using GC (Agilent Technologies) equipped with a DB-FFAP (60 m×250 μm×0.25 μm) column and a flame ionization detector (FID). The analysis results were calculated by measuring the peak area ratio of the internal standard substance, diphenylmethane, and the sample.

The high-performance liquid chromatography analysis was carried out using HPLC (Agilent Technologies) equipped with a Capcell Pak C18 MG (4.6 mm×250 mm×5 μm) column and a diode array detector (DAD) of a 210-nm wavelength. A 0.2% aqueous phosphoric acid solution and acetonitrile containing 0.2% phosphoric acid were used as a solvent for the mobile phase by varying the concentration, and the flow rate was 1 mL/minute.

Vacuum fractional distillation was carried out to separate the non-polar aprotic solvent and each monomer from the separated upper layer (organic layer). The vacuum fractional distillation was carried out at a temperature of 100° C. to 130° C. under reduced pressure at 100 Torr. As a result, 1,4-dioxane (non-polar aprotic solvent), and lactic acid or butyl lactic acid (butyl LA) as a derivative thereof were separated. The monomerization conversion yield of butyl lactic acid (butyl LA) thus obtained was confirmed.

### Example 2

The same procedure as in Example 1 was carried out, except that a polyhydroxyalkanoate (PHA, 3-HB-co-4-HB) (CJ Cheil Jedang Co., Ltd.) was used as a biodegradable polymer. As a result, 1,4-dioxane (non-polar aprotic solvent) was separated, and butyl 3-hydroxybutyrate (butyl 3-HB) and butyl 4-hydroxybutyrate (butyl 4-HB) with high boiling points were obtained in the form of a mixture. The monomerization conversion yield of butyl 3-hydroxybutyrate (butyl 3-HB) and butyl 4-hydroxybutyrate (butyl 4-HB) thus obtained was confirmed.

### Example 3

The same procedure as in Example 1 was carried out, except that a mixture of a polylactic acid and a polyhydroxyalkanoate (PHA, 3-HB-co-4-HB) at a weight ratio of 70:30 was used. As a result, 1,4-dioxane (non-polar aprotic solvent) was separated, and butyl lactic acid (butyl LA), butyl 3-hydroxybutyrate (butyl 3-HB), and butyl 4-hydroxybutyrate (butyl 4-HB) were obtained. The monomerization conversion yield of butyl lactic acid (butyl LA), butyl 3-hydroxybutyrate (butyl 3-HB), and butyl 4-hydroxybutyrate (butyl 4-HB) thus obtained was confirmed.

### Example 4

The same procedure as in Example 1 was carried out, except that a mixture of a polylactic acid and a polyhydroxyalkanoate (PHA, 3-HB-co-4-HB) at a weight ratio of 50:50 was used. As a result, 1,4-dioxane (non-polar aprotic solvent) was separated, and butyl lactic acid (butyl LA), butyl 3-hydroxybutyrate (butyl 3-HB), and butyl 4-hydroxybutyrate (butyl 4-HB) were obtained. The monomerization conversion yield of butyl lactic acid (butyl LA), butyl 3-hydroxybutyrate (butyl 3-HB), and butyl 4-hydroxybutyrate (butyl 4-HB) thus obtained was confirmed.

### Example 5

The same procedure as in Example 1 was carried out, except that a mixture of a polylactic acid and a polyhydroxyalkanoate (PHA, 3-HB-co-4-HB) at a weight ratio of 32:68 was used. As a result, 1,4-dioxane (non-polar aprotic solvent) was separated, and butyl lactic acid (butyl LA), butyl 3-hydroxybutyrate (butyl 3-HB), and butyl 4-hydroxybutyrate (butyl 4-HB) were obtained. The monomerization conversion yield of butyl lactic acid (butyl LA), butyl 3-hydroxybutyrate (butyl 3-HB), and butyl 4-hydroxybutyrate (butyl 4-HB) thus obtained was confirmed.

### Example 6

The same procedure as in Example 1 was carried out, except that the reaction temperature was 120° C. As a result, 1,4-dioxane (non-polar aprotic solvent) and lactic acid or butyl lactic acid (butyl LA) as a derivative thereof were separated. The monomerization conversion yield of butyl lactic acid (butyl LA) thus obtained was confirmed.

### Example 7

The same procedure as in Example 3 was carried out, except that the reaction temperature was 120° C. As a result, 1,4-dioxane (non-polar aprotic solvent) was separated, and butyl lactic acid (butyl LA), butyl 3-hydroxybutyrate (butyl 3-HB), and butyl 4-hydroxybutyrate (butyl 4-HB) were obtained. The monomerization conversion yield of butyl lactic acid (butyl LA), butyl 3-hydroxybutyrate (butyl 3-HB), and butyl 4-hydroxybutyrate (butyl 4-HB) thus obtained was confirmed.

### Comparative Example 1

The same procedure as in Example 3 was carried out, except that butanol (n-butanol) as a primary alcohol and 1,4-dioxane as a non-polar aprotic solvent were mixed at a volume ratio of 1:1 to prepare a solution, and diphenylmethane was dissolved in the solution at a concentration of 2 g/L to prepare a composition for depolymerization. As a result, 1,4-dioxane (non-polar aprotic solvent) was separated, and butyl lactic acid (butyl LA), butyl 3-hydroxybutyrate (butyl 3-HB), and butyl 4-hydroxybutyrate (butyl 4-HB) were obtained. The monomerization conversion yield of butyl lactic acid (butyl LA), butyl 3-hydroxybutyrate (butyl 3-HB), and butyl 4-hydroxybutyrate (butyl 4-HB) thus obtained was confirmed.

### Comparative Example 2

The same procedure as in Example 3 was carried out, except that the reaction temperature was 60° C. As a result, 1,4-dioxane (non-polar aprotic solvent) was separated, and butyl lactic acid (butyl LA), butyl 3-hydroxybutyrate (butyl 3-HB), and butyl 4-hydroxybutyrate (butyl 4-HB) were obtained. The monomerization conversion yield of butyl lactic acid (butyl LA), butyl 3-hydroxybutyrate (butyl 3-HB), and butyl 4-hydroxybutyrate (butyl 4-HB) thus obtained was confirmed.

### Comparative Example 3

Butanol (n-butanol) as a primary alcohol and 1,4-dioxane (non-polar aprotic solvent) were mixed at a volume ratio of 1:1 to prepare a solution. Diphenylmethane was dissolved in the solution at a concentration of 2 g/L to prepare a composition for depolymerization.

A screw-capped glass test tube was charged with a polylactic acid (PLA), a biodegradable polymer, the composition for depolymerization, and tin (II) 2-ethylhexanoate (Sn(oct)₂) as a metal catalyst, and they were reacted in a hot water bath at 95° C. Here, the mixing weight ratio of the metal catalyst and biodegradable polymer is shown in Table 4.

Upon completion of the reaction, the monomer was separated and recovered in the same manner as in Example 1 and analyzed by gas chromatography and high-performance liquid chromatography to confirm the monomerization conversion yield of butyl lactic acid (butyl LA).

### Comparative Example 4

The same procedure as in Comparative Example 3 was carried out, except that a mixture of a polylactic acid and a polyhydroxyalkanoate (PHA, 3-HB-co-4-HB) at a weight ratio of 70:30 was used. As a result, 1,4-dioxane (non-polar aprotic solvent) was separated, and monomers were obtained. The monomerization conversion yield of the monomers thus obtained was confirmed.

### Comparative Example 5

The same procedure as in Comparative Example 3 was carried out, except that a mixture of a polylactic acid and a polyhydroxyalkanoate (PHA, 3-HB-co-4-HB) at a weight ratio of 70:30 was used, and the mixing weight ratio of the catalyst and the polymer was changed as shown in Table 4 below. As a result, 1,4-dioxane (non-polar aprotic solvent) was separated, and monomers were obtained. The monomerization conversion yield of the monomers thus obtained was confirmed.

### Comparative Example 6

The same procedure as in Comparative Example 3 was carried out, except that p-toluene sulfonic acid (p-TSA) was used as a metal catalyst. As a result, 1,4-dioxane (non-polar aprotic solvent) and lactic acid or butyl lactic acid (butyl LA) as a derivative thereof were separated. The monomerization conversion yield of butyl lactic acid (butyl LA) thus obtained was confirmed.

### Comparative Example 7

The same procedure as in Comparative Example 3 was carried out, except that a mixture of a polylactic acid and a polyhydroxyalkanoate (PHA, 3-HB-co-4-HB) at a weight ratio of 70:30 was used, and p-toluene sulfonic acid (p-TSA) was used as a metal catalyst. As a result, 1,4-dioxane (non-polar aprotic solvent) was separated, and butyl lactic acid (butyl LA), butyl 3-hydroxybutyrate (butyl 3-HB), and butyl 4-hydroxybutyrate (butyl 4-HB) were obtained. The monomerization conversion yield of butyl lactic acid (butyl LA), butyl 3-hydroxybutyrate (butyl 3-HB), and butyl 4-hydroxybutyrate (butyl 4-HB) thus obtained was confirmed.

### Comparative Example 8

The same procedure as in Comparative Example 7 was carried out, except that the mixing weight ratio of the catalyst and the polymers was changed as shown in Table 4 below. As a result, 1,4-dioxane (non-polar aprotic solvent) was separated, and monomers were obtained. The monomerization conversion yield of the monomers thus obtained was confirmed.

### Comparative Example 9

The same procedure as in Example 1 was carried out, except that butanol (n-butanol) as a primary alcohol and ethyl lactate (EtLA) dissolved 4M hydrochloric acid as a Brønsted-Lowry acid catalyst were mixed at a volume ratio of 1:1 to prepare a solution, and diphenylmethane was dissolved in the solution at a concentration of 2 g/L to prepare a composition for depolymerization. As a result, 1,4-dioxane (non-polar aprotic solvent) was separated, and monomers were obtained. The monomerization conversion yield of the monomers thus obtained was confirmed.

Meanwhile, in the present disclosure, the monomerization conversion yield may be calculated by the following Equation 1:

$$Monomerization conversion yield ( \% ) = \frac{{W}_{r}}{{W}_{p}} \times 100 \qquad [ Equation 1 ]$$

In Equation 1, Wₚ is the weight (% by weight) of the biodegradable polymer, and W, is the total weight (% by weight) of the monomerization-converted materials produced.

The results of comparing the monomerization conversion yield according to the type of biodegradable polymer are summarized in Table 1 below.

TABLE 1

| | | Monomerization | | |
|---|---|---|---|---|
| | | conversion yield (%) | | |
| | | Butyl | Butyl | Butyl |
| | Polymer (weight ratio) | LA | 3-HB | 4-HB |
| Example 1 | PLA | 88.3 | — | — |
| Example 2 | PHA (3-HB-co-4-HB) | — | 100 | 100 |
| Example 3 | PLA/PHA (3-HB-co-4-HB) | 82.1 | 100 | 100 |
| | (70/30) | | | |
| Comparative | PLA/PHA (3-HB-co-4-HB) | 0.0 | 0.0 | 0.0 |
| Example 1 | (70/30) | | | |

As can be seen from Table 1 above, the monomerization conversion yield of units (monomers) derived from the biodegradable polymers in Examples 1 to 3 was confirmed to be 80% or more even at a low temperature of about 95° C.

In contrast, in Comparative Example 1 in which a Brønsted-Lowry acid catalyst was not used, monomerization was not carried out.

In addition, the results of comparing the monomerization conversion yield with respect to the mixing ratio of the polylactic acid and the polyhydroxyalkanoate (PHA, 3-HB-co-4-HB) are summarized in Table 2 below.

TABLE 2

| | | Monomerization | | |
|---|---|---|---|---|
| | | conversion yield (%) | | |
| | | Butyl | Butyl | Butyl |
| | Polymer (weight ratio) | LA | 3-HB | 4-HB |
| Example 4 | PLA/PHA (3-HB-co-4-HB) | 82.0 | 100.0 | 88.6 |
| | (50/50) | | | |
| Example 5 | PLA/PHA (3-HB-co-4-HB) | 80.8 | 100.0 | 89.3 |
| | (32/68) | | | |

As can be seen from Table 2 above, even when the mixing ratio of the polylactic acid and the polyhydroxyalkanoate (PHA, 3-HB-co-4-HB) was different, the monomerization conversion yield of units derived from the biodegradable polymer was confirmed to be 80% or more.

The results of comparing the monomerization conversion yield according to the reaction temperature in the hot water bath are summarized in Table 3 below.

TABLE 3

| | | | Monomerization | | |
|---|---|---|---|---|---|
| | | | conversion yield (%) | | |
| | | Reaction | Butyl | Butyl | Butyl |
| | Polymer (weight ratio) | temp. | LA | 3-HB | 4-HB |
| Comparative | PLA/PHA | 60° C. | 31.8 | 47.8 | 37.9 |
| Example 2 | (3-HB-co-4-HB) | | | | |
| | (70/30) | | | | |
| Example 6 | PLA | 120° C. | 84.1 | — | — |
| Example 7 | PLA/PHA | 120° C. | 97.3 | 100.0 | 98.6 |
| | (3-HB-co-4-HB) | | | | |
| | (70/30) | | | | |

As can be seen from Table 3 above, the monomerization conversion yield of units derived from the biodegradable polymers was confirmed to be about 80% or more even at a reaction temperature of about 95° C. and 120° C. In particular, when the reaction temperature was 120° C. as in Examples 6 and 7, a monomerization conversion yield of about 84% or more was achieved. For a mixture of the polylactic acid and the polyhydroxyalkanoate (PHA, 3-HB-co-4-HB), a monomerization conversion yield of about 97% or more was confirmed.

In contrast, when the reaction temperature was 60° C. as in Comparative Example 2, the monomerization conversion yield of units derived from the biodegradable polymers was about 30% to about 47%, which was significantly reduced as compared with Example 7.

In addition, the results of comparing the monomerization conversion yield according to the type of catalyst in the process for regenerating a biodegradable polymer are summarized in Table 4 below.

TABLE 4

| | | | | Monomerization | | |
|---|---|---|---|---|---|---|
| | | | | conversion yield (%) | | |
| | | | weight ratio of | Butyl | Butyl | Butyl |
| | Polymer (weight ratio) | Catalyst | catalyst/polymer | LA | 3-HB | 4-HB |
| Comparative | PLA | Sn(oct)₂ | 1 | 69.7 | — | — |
| Example 3 | | | | | | |
| Comparative | PLA/PHA (3-HB-co-4-HB) | Sn(oct)₂ | 1 | 66.3 | 0 | 51.3 |
| Example 4 | (70/30) | | | | | |
| Comparative | PLA/PHA (3-HB-co-4-HB) | Sn(oct)₂ | 0.1 | 0 | 0 | 13.8 |
| Example 5 | (70/30) | | | | | |
| Comparative | PLA | p-TSA | 1 | 19.8 | — | — |
| Example 6 | | | | | | |
| Comparative | PLA/PHA (3-HB-co-4-HB) | p-TSA | 1 | 17.4 | 45.9 | 25 |
| Example 7 | (70/30) | | | | | |
| Comparative | PLA/PHA (3-HB-co-4-HB) | p-TSA | 0.1 | 1.1 | 0 | 14.7 |
| Example 8 | (70/30) | | | | | |

As can be seen from Table 4 above, in Comparative Examples 3 to 8 in which a metal catalyst was used, the monomerization conversion yield was 70% or less. In particular, when p-TSA was used as a metal catalyst, the monomerization conversion yield was confirmed to be 50% or less.

In addition, when Sn(oct)₂ was used as a metal catalyst, the monomerization conversion yield of butyl 3-hydroxybutyrate (butyl 3HB) from a mixture of the polylactic acid and the polyhydroxyalkanoate (PHA, 3-HB-co-4-HB) was 0, indicating that no monomer conversion was carried out.

Meanwhile, the monomerization conversion yield when ethyl lactate was used as a solvent in the process for regenerating a biodegradable polymer is shown in Table 5 below.

TABLE 5

| | | | | Monomerization | | |
|---|---|---|---|---|---|---|
| | | | | conversion yield (%) | | |
| | | | | Butyl | Butyl | Butyl |
| | Polymer | Solvent | Catalyst | LA | 3-HB | 4-HB |
| Comparative | PLA/PHA (3-HB-co-4-HB) | EtLA | Hydrochloric acid | 7.2 | 0.0 | 0.0 |
| Example 9 | (70/30) | | | | | |

As can be seen from Table 5 above, in Comparative Example 9 in which ethyl lactate was used as a solvent, about 7.2% of butyl lactic acid (butyl LA) and 0% of butyl 3-hydroxybutyrate (butyl 3-HB) and butyl 4-hydroxybutyrate (butyl 4-HB) were obtained. Thus, it was confirmed that almost no monomer conversion was carried out from the above mixture when ethyl lactate was used as a solvent.

1. A process for regenerating a biodegradable polymer, which comprises:
reacting a biodegradable polymer with a composition for depolymerization to obtain a monomer mixture,
wherein the biodegradable polymer comprises a polylactic acid (PLA), a polyhydroxyalkanoate (PHA), or a combination thereof,
the composition for depolymerization comprises a primary alcohol, a non-polar aprotic solvent, and a Brønsted-Lowry acid catalyst, and
the reaction is carried out at 90° C. or higher.

2. The process for regenerating a biodegradable polymer of claim 1, wherein the biodegradable polymer comprises a polylactic acid (PLA) and a polyhydroxyalkanoate (PHA), and the weight ratio of the polylactic acid (PLA) and the polyhydroxyalkanoate (PHA) is 1:9 to 9:1.

3. The process for regenerating a biodegradable polymer of claim 2, wherein the monomer mixture comprises lactic acid or a derivative thereof, 3-hydroxybutyrate or a derivative thereof, and 4-hydroxybutyrate or a derivative thereof.

4. The process for regenerating a biodegradable polymer of claim 1, wherein the Brønsted-Lowry acid catalyst comprises at least one selected from the group consisting of sulfuric acid, hydrochloric acid, and nitric acid.

5. The process for regenerating a biodegradable polymer of claim 1, wherein the non-polar aprotic solvent comprises at least one selected from the group consisting of 1,4-dioxane, and chloroform.

6. The process for regenerating a biodegradable polymer of claim 1, wherein the primary alcohol is ethanol, butanol, or a combination thereof.

7. The process for regenerating a biodegradable polymer of claim 1, which further comprises preparing the composition for depolymerization, wherein the step of preparing the composition for depolymerization comprises mixing the primary alcohol and the non-polar aprotic solvent in which the Brønsted-Lowry acid catalyst is dissolved at a volume ratio of 1:0.2 to 20.

8. The process for regenerating a biodegradable polymer of claim 1, wherein the Brønsted-Lowry acid catalyst is employed in an amount of 0.01 to 100 equivalents based on the total weight of the composition for depolymerization.

9. The process for regenerating a biodegradable polymer of claim 1, wherein the reaction is carried out at 90° C. to 120° C.

10. The process for regenerating a biodegradable polymer of claim 1, wherein the process for regenerating a biodegradable polymer has a monomerization conversion yield of 80% or more.

11. The process for regenerating a biodegradable polymer of claim 1, which further comprises, after obtaining the monomer mixture, carrying out a distillation process to separate a monomer from the monomer mixture and recover it.

12. The process for regenerating a biodegradable polymer of claim 11, which further comprises, after obtaining the monomer mixture and before the distillation process, separating the monomer mixture into two layers using liquid-liquid extraction.

13. The process for regenerating a biodegradable polymer of claim 11, wherein the distillation process is carried out at a temperature of 50° C. to 250° C. and a reduced pressure of 10 to 760 Torr.

14. The process for regenerating a biodegradable polymer of claim 11, which further comprises repolymerizing the recovered monomer to obtain a biodegradable polymer.
